(19) United States
(12) Patent Application Publication
(10) Pub. No.: US 2005/0260459 A1
(43) Pub. Date: Nov. 24, 2005

(54) Magnetic recording medium

(75) Inventors: Kazuko Hanai, Kanagawa (JP); Ayako Matsumoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/132,406

(22) Filed: May 19, 2005

(30) Foreign Application Priority Data
May 19, 2004 (JP) 2004-148749

(51) Int. Cl. G11B 5/716

(52) U.S. Cl. 428/847.1; 428/847.2; 428/840.2

(57) ABSTRACT

A magnetic recording medium comprising: a nonmagnetic support having a first surface and a second surface; and a magnetic layer containing ferromagnetic powder and a binder, so that the magnetic layer, the first surface and the second surface are in this order, wherein the nonmagnetic support contains polyester, a difference between largest ratio and smallest ratio among peak intensity ratios of gauche/trans on the first and second surfaces of the support in a machine direction and a transverse direction obtained by ATR-FT-IR method is 0.030 or less in an absolute value, and a shrinkage factor of the magnetic recording medium after preservation at 70° C. 5% RH for one week is 0.040% or less.

### FIELD OF THE INVENTION

The present invention relates to a magnetic recording medium, more specifically relates to a magnetic recording medium conspicuously improved in durability, preservation stability and high density recording characteristics by improving a thermal shrinkage factor and inhibiting curling.

### BACKGROUND OF THE INVENTION

In the field of the magnetic disc, a 2 MB MF-2HD floppy disc using a Co-modified iron oxide has been generally loaded on a personal computer. However, along with the rapid increase in the amount of data to be dealt with, the capacity of discs has become insufficient and the increase in the capacity of floppy discs has been demanded.

Increase in recording capacity and improvement of data transfer speed have been strongly demanded particularly conjointly with the miniaturization of a computer and the increase in throughput.

A magnetic layer comprising an iron oxide, a Co-modified iron oxide, CrO₂, ferromagnetic metal powder, or hexagonal ferrite powder dispersed in a binder coated on a nonmagnetic support has been conventionally widely used in magnetic recording media. Of these magnetic powders, ferromagnetic metal powders and hexagonal ferrite fine powders are known to be excellent in high density recording characteristics.

In the case of disc, as high capacity discs using ferromagnetic metal powders excellent in high density recording characteristics, 10 MB MF-2TD and 21 MB MF-2SD, and as high capacity discs using hexagonal ferrite, 4 MB MF-2ED and 21 MB Floptical are known, but any of these discs are not satisfactory with respect to capacities and performances. As is the circumstance, various attempts have been made to improve high density recording characteristics. The examples of the attempts are described below.

For improving characteristics of a disc-like gnetic recording medium, JP-A-64-844 18 (The term “JP-A” as used herein refers to an “unexamined published Japanese patent application”) proposes the use of a vinyl chloride resin having an acidic group, an epoxy group and a hydroxyl group, JP-B-3-12374 (The term “JP-B” as used herein refers to an “examined Japanese patent publication”) proposes the use of metallic fine powder having Hc of 79,600 A/m (1,000 Oe) or more and a specific surface area of from 25 to 70 m²/g, and JP-B-6-28106 proposes to regulate the specific surface area and magnetic susceptibility of magnetic powder and contain an abrasive.

For improving the durability of a disc-like magnetic recording medium, JP-B-7-85304 proposes the use of a fatty acid ester having an unsaturated fatty acid ester and an ether bond, JP-B-7-70045 proposes the use of a fatty acid ester having a branched fatty acid ester and an ether bond, JP-A-54-124716 proposes the use of nonmagnetic powder having a Mohs' hardness of 6 or more and a higher fatty acid ester, JP-B-7-89407 proposes to regulate the cubic volume of voids containing a lubricant and regulate the surface roughness to 0.005 to 0.025 μm, JP-A-61-294637 proposes the use of a fatty acid ester having a low melting point and a fatty acid ester having a high melting point, JP-B-7-36216 proposes the use of an abrasive having a particle size of from ¼ to ¾ of a magnetic layer thickness and a fatty acid ester having a low melting point, and JP-A-3-203018 proposes the use of metal powder containing Al and a chromium oxide.

As the constitution of a disc-like magnetic recording medium having a nonmagnetic lower layer and an intermediate layer, JP-A-3-120613 proposes a constitution comprising an electrically conductive layer and a magnetic layer containing metallic fine powder, JP-A-6-290446 proposes a constitution comprising a magnetic layer having a thickness of 1 μm or less and a nonmagnetic layer, JP-A-62-159337 proposes a constitution comprising an intermediate layer comprising a carbon and a magnetic layer containing a lubricant, JP-A-5-290358 proposes a constitution comprising a nonmagnetic layer in which the carbon size is regulated, and JP-A-8-249649 proposes to regulate the cubic volume of voids in a lower coating layer and an upper magnetic layer and to provide puddles of a fluid lubricant.

On the other hand, a disc-like magnetic recording medium comprising a thin magnetic layer and a functional nonmagnetic layer has been developed in recent years and floppy discs of the class with the capacity of 100 MB are now on the market. As floppy discs showing these characteristics, JP-A-5-109061 proposes a constitution comprising a magnetic layer having Hc of 111,440 A/m (1,400 Oe) or more and a thickness of 0.5 μm or less and a nonmagnetic layer containing electrically conductive particles, JP-A-5-197946 proposes a constitution comprising a magnetic layer containing an abrasive having a particle size larger than the thickness of the magnetic layer, JP-A-5-290354 proposes a constitution comprising a magnetic layer having a thickness of 0.5 μm or less with the fluctuation of the thickness being within ±15% and the surface electric resistance is regulated, and JP-A-6-68453 proposes a constitution in which two kinds of abrasives having different particle sizes are contained and the amount of the abrasives on the surface is regulated. Reliability on performance, such as stable recording and readout of data in multiple running due to repeating use at high speed has been increasingly demanded. A magnetic recording medium containing at least one abrasive selected from alumina, chromium oxide and diamond is disclosed in JP-A-6-52541, and the same patent discloses that the running durability can be improved by the use of these powders having high hardness.

In such a high capacity disc medium, linear recording density and track density are increased and the area per 1 Bit of signal is drastically decreased. Accordingly, a trifle warp on a disc results in a fatal defect in the recording and reproduction of a signal. That is, even a minute curl that is negligible for the revolving speed of conventional media becomes a cause of tracking deviation the more the density increases. In addition, preservation stability is important for a magnetic recording medium, and tracking becomes difficult when a trace of shrinkage is present in particular in a high density magnetic recording medium in the plane direction of the medium after high temperature preservation similarly to the case of curling, so that it is also important to inhibit the shrinkage due to preservation.

### SUMMARY OF THE INVENTION

An object of the present invention is to provide a magnetic recording medium conspicuously improved in durability, preservation stability and high density recording characteristics by the improvement of a thermal shrinkage factor and the inhibition of curling (warp).

The invention is as follows.

(1) A magnetic recording medium comprising a nonmagnetic support having provided thereon a magnetic layer containing ferromagnetic powder dispersed in a binder, wherein the nonmagnetic support is a polyester support, a difference between the largest ratio and the smallest ratio among peak intensity ratios of gauche/trans on the obverse surface (first surface) and the reverse surface (second surface) of the polyester support in a machine direction and a transverse direction (a peak intensity ratio of gauche/trans on the obverse surface in the machine direction, a peak intensity ratio of gauche/trans on the obverse surface in the transverse direction, a peak intensity ratio of gauche/trans on the reverse surface in the machine direction and a peak intensity ratio of gauche/trans on the reverse surface in the transverse direction) found by ATR-FT-IR method is 0.030 or less in the absolute value, and the shrinkage factor of the magnetic recording medium after preservation at 70° C. 5% RH for one week is 0.040% or less.

(2) The magnetic recording medium as described in the above item (1), wherein a substantially nonmagnetic lower layer and a magnetic layer containing ferromagnetic powder dispersed in a binder are provided on the nonmagnetic support in this order.

(3) The magnetic recording medium as described in the above item (1) or (2), wherein the difference between the largest ratio and the smallest ratio among peak intensity ratios of gauche/trans on the first and second surfaces of the support in a machine direction and a transverse direction obtained by ATR-FT-IR method is 0.02 or less in the absolute value.

(4) The magnetic recording medium as described in the above item (3), wherein the polyester support is a polyethylene-naphthalate support.

As a result of eager examination for achieving the above object, the present inventors have found that when a minute curl is present in a magnetic recording medium such as a floppy disc, tracking is difficult at periphery and characteristics are deteriorated. As a result of further examination on the obverse and reverse surfaces of the polyester support of a magnetic recording medium by ATR-FT-IR method, the present inventors found that there is no difference in the degree of amorphism in polyester that does not generate curling as compared with polyester that generates curling. That is, the difference between the largest ratio and the smallest ratio among the gauche/trans peak intensity ratios as the index of an amorphous part on the obverse and reverse surfaces of the polyester support is not so great.

That is, the degree of crystal/amorphous of polyester is influenced by heat hysteresis and stretching in the manufacturing process, but an amorphous part is in a non-equilibrium state having an excess volume, and the volume shrinks and the bulk density increases when the polyester is heated at a glass transition temperature or lower, so that the support curls to a direction greater in the degree of amorphism. However, this problem of curling can be solved by the design so that the difference between the largest ratio and the smallest ratio among the gauche/trans peak intensity ratios on the obverse and reverse surfaces of the support is not so great. Further, according to the invention, a magnetic recording medium conspicuously improved in durability, preservation stability and high density recording characteristics can be obtained by setting a thermal shrinkage factor at rather low value.

### DETAILED DESCRIPTION OF THE INVENTION

The invention will be described in detail below.

Nonmagnetic Support:

Polyester supports for use in the invention as a nonmagnetic supports (hereinafter referred to as merely “polyester”) are polyesters comprising dicarboxylic acid and diol, such as polyethylene naphthalate and polyethylene terephthalate.

As the dicarboxylic acid components of main constitutional components of polyesters, terephthalic acid, isophthalic acid, phthalic acid, 2,6-naphthalenedicarboxylic acid, 2,7-naphthalenedicarboxylic acid, diphenyl sulfone dicarboxylic acid, diphenyl ether dicarboxylic acid, diphenylethanedicarboxylic acid, cyclohexanedicarboxylic acid, diphenyldicarboxylic acid, diphenyl thioether dicarboxylic acid, diphenyl ketone dicarboxylic acid, and phenylindanedicarboxylic acid can be exemplified.

As the diol components, ethylene glycol, propylene glycol, tetramethylene glycol, cyclohexanedimethanol, 2,2-bis(4-hydroxyphenyl)propane, 2,2-bis(4-hydroxyethoxyphenyl)propane, bis(4-hydroxyphenyl)sulfone, bisphenol fluorene dihydroxy ethyl ether, diethylene glycol, neopentyl glycol, hydroquinone, and cyclohexanediol can be exemplified.

Of polyesters comprising these dicarboxylic acids and diols as main constitutional components, from the points of transparency, mechanical strength and dimensional stability, polyesters mainly comprising terephthalic acid and/or 2,6-naphthalenedicarboxylic acid as the dicarboxylic acid components, and ethylene glycol and/or 1,4-cyclohexane-dimethanol as the diol components are preferred.

Of these polyesters, polyesters mainly comprising polyethylene terephthalate or polyethylene-2,6-naphthalate, polyesters copolymers comprising terephthalic acid, 2,6-naphthalenedicarboxylic acid and ethylene glycol, and polyesters mainly comprising mixtures of two or more of these polyesters are preferred. Polyesters mainly comprising polyethylene-2,6-naphthalate are particularly preferred.

Polyesters for use in the invention may be biaxially stretched or may be laminates of two or more layers.

Polyesters for use in the invention may be copolymerized with other copolymer components or mixed with other polyesters so long as they do not hinder the effect of the invention. As the examples thereof, the aforementioned dicarboxylic acid components, diol components, and polyesters comprising these components are exemplified.

For the purpose of hardly causing delamination when polyester is formed as a film, polyesters for use in the invention may be copolymerized with aromatic dicarboxylic acids having a sulfonate group or ester formable derivatives of them, dicarboxylic acids having a polyoxyalkylene group or ester formable derivatives of them, or diols having a polyoxyalkylene group.

Of these copolymerizable compounds, from the points of polymerization reactivity of polyesters and transparency of films, sodium 5-sulfoisophthalate, sodium 2-sulfoterephthalate, sodium 4-sulfophthalate, sodium 4-sulfo-2,6-naphthalenedicarboxylate, compounds obtained by substituting the sodium of the above compounds with other metals (e.g., potassium, lithium, etc.), ammonium salt or phosphonium salt, or ester formable derivatives of them, polyethylene glycol, polytetramethylene glycol, polyethylene glycol-polypropylene glycol copolymers, and compounds obtained by oxidizing both terminal hydroxyl groups of these compounds to make carboxyl groups are preferably used. The proportion of the copolymerization of these compounds for this purpose is preferably from 0.1 to 10 mol % on the basis of the amount of the dicarboxylic acids constituting the polyesters.

For improving heat resistance, bisphenol compounds, and compounds having a naphthalene ring or a cyclohexane ring can be copolymerized with polyesters. The proportion of the copolymerization of these compounds is preferably from 1 to 20 mol % on the basis of the amount of the dicarboxylic acids constituting the polyesters.

The synthesizing method of polyesters is not especially restricted in the invention, and well-known manufacturing methods of polyesters can be used. For example, a direct esterification method of directly esterification reacting dicarboxylic acid component and diol component, and an ester exchange method of performing ester exchange reaction of dialkyl ester as the dicarboxylic acid component and diol component in the first place, and then polymerizing the ester exchanged product by heating under reduced pressure to remove the excessive diol component can be used. At this time, if necessary, an ester exchange catalyst, a polymerization reaction catalyst or a heat resistive stabilizer can be added.

Further, one or two or more kinds of various additives, such as a coloring inhibitor, an antioxidant, a crystal nucleus agent, a sliding agent, a stabilizer, a blocking preventive, an ultraviolet absorber, a viscosity adjustor, a defoaming and clarifying agent, an antistatic agent, a pH adjustor, a dye, a pigment and a reaction stopper may be added in each process of synthesis.

It is necessary that the polyesters for use in the invention have the difference between the largest ratio and the smallest ratio among the peak intensity ratios of gauche/trans on the obverse and reverse surfaces in the machine direction (MD) and the transverse direction (TD) found by ATR-FT-IR method of 0.030 or less in the absolute value. When the difference exceeds 0.02, it becomes impossible to inhibit curling. The difference is preferably 0.02 or less, more preferably 0.016 or less

The peak intensity ratio of gauche/trans by ATR-FT-IR method is obtained by the measurement of respectively the gauche structure generated by internal rotation with a carbon-carbon bond of glycol unit as the axis, and the trans structure according to an ordinary method. For example, when polyethylene naphthalate is used as polyester, the measurement is performed with Nexus 670 (a trade name, manufactured by Thermo-Nicolet) and reflection ATR accessory at resolution of 1 cm⁻¹ and integration of 200 times. The index of the degree of an amorphous part is obtained by finding the ratio of the absorbance of peak of γω(CH₂) gauche of 1,370 cm⁻¹ to the absorbance of weak of γω(CH₂) trans of 1,337 cm⁻¹.

For making the difference of the peak intensity ratio of gauche/trans found by ATR-FT-IR method 0.030 or less, it is sufficient to optionally set the heat hysteresis and the stretching conditions in manufacturing process of polyester. For example, when polyethylene naphthalate is used as polyester and the peak intensity ratio is set by varying the heat hysteresis, it is effective to perform stretching as far as possible and then lower the temperature slowly to effect crystallization, and when the peak intensity ratio is set by modifying stretching conditions, it is sufficient to broaden the stretching conditions and perform crystallization by orientation.

For example, by using a well-known extruder, polyester is extruded from a nozzle in the form of a sheet at temperature of from a melting point (Tm) to Tm+70° C., and then the extruded polyester is suddenly cooled and set at 40 to 90° C., whereby a laminated unstretched film is obtained. After that, the unstretched film is stretched by an ordinary method in a uniaxial direction by 2.5 to 4.5 times, preferably from 2.8 to 3.9 times, at a temperatures around (glass transition temperature (Tg)−10° C.) to (Tg+70° C.), and then in the right angle direction to the former direction by 4.5 to 8.0 times, preferably from 4.5 to 6.0 times, at a temperatures around Tg to (Tg+70° C.), and further if necessary, in the machine direction and/or transverse direction, whereby a biaxially oriented film is obtained. That is, it is preferred to perform stretching of two stages, three stages, four stages, or multi-stages. The total stretch magnification is generally 12 times or more in terms of area stretch magnification, preferably from 12 to 32 times, more preferably from 14 to 26 times. It is preferred for the biaxially oriented film to be subjected to subsequent heat fixation crystallization at temperature of from (Tg+70C) to (Tm−10° C.), e.g., from 180 to 250° C. The time of heat fixation is preferably from 1 to 60 seconds.

Fillers may be added to the polyesters. As the kinds of fillers, inorganic powders, e.g., spherical silica, colloidal silica, titanium oxide and alumina, and organic fillers, e.g., crosslinked polystyrene and silicone resins are exemplified.

In the invention, the thickness of a polyester support is preferably from 10 to 100 μm, more preferably from 20 to 80 μm. The central line average surface roughness (Ra) of the surface of a support is preferably 8 nm or less, more preferably 6 nm or less. Ra was measured with a surface roughness meter TOPO-3D (a product manufactured by WYKO Co.).

The magnetic recording medium in the invention comprises the nonmagnetic support having provided thereon a magnetic layer containing ferromagnetic powder dispersed in a binder, and if necessary, a nonmagnetic layer (a lower layer) being substantially nonmagnetic may be provided between the support and the magnetic layer. The components of each layer constituting the magnetic recording medium, the layer constitution, and the specific manufacturing method of the magnetic recording medium are described below in sequence.

Magnetic Layer:

The ferromagnetic powders contained in a magnetic layer have a cubic volume of preferably (0.1 to 8)×10⁻¹⁸ ml, more preferably (0.5 to 5)×10⁻¹⁸ ml. When the cubic volume of the ferromagnetic powders is in the range, the reduction of magnetic characteristics due to thermal fluctuation can be effectively prevented and at the same time good C/N (S/N) can be obtained while maintaining noise at a low leve. The ferromagnetic powders are preferably ferromagnetic metal powders and hexagonal ferrite powders.

The cubic volume of ferromagnetic powders can be found as follows.

In the case of ferromagnetic metal powders, the cubic volume is obtained from the long axis length and the short axis length taking the shape as cylindrical. In the case of hexagonal ferrite powders, the cubic volume is obtained from the tabular diameter and the axis length (tabular thickness) taking the shape as a hexagonal pole.

For finding a particle size of a magnetic substance, a proper amount of a magnetic layer is peeled off n-Butylamine is added to 30 to 70 mg of the peeled magnetic layer, and they are sealed in a glass tube, the glass tube is set on a pyrolysis apparatus and heated at 140° C. for about one day. After cooling, the content is taken out of the glass tube and centrifuged to thereby separate liquid and solid. The separated solid is washed with acetone to obtain a powder sample for TEM. The particles of the sample are photographed with a transmission electron microscope H-9000 (manufactured by Hitachi Limited) with magnifications of 100,000, and a photograph of the particle is printed on a photographic paper in the total magnifications of 500,000. By selecting an objective magnetic particle from the photographs of the particles and mounting it on an image analyzer KS-400 digitizer (manufactured by Kontron), and tracing the outline of each particle, and the size of each particle is measured. The measurement of size is performed with 500 particles, and the measured values are averaged to obtain an average particle size.

Ferromagnetic Metal Powder:

The ferromagnetic metal powders for use in a magnetic layer of the magnetic recording medium in the invention are not particularly restricted so long as they contain Fe as the main component (including alloys), but ferromagnetic alloy powders comprising α-Fe as the main component are preferably used. These ferromagnetic powders may contain, in addition to the prescribed atoms, e.g., Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr and B. Ferromagnetic powders containing at least one of Al, Si, Ca, Y, Ba, La, Nd, Co, Ni and B in addition to α-Fe are preferred, and those containing Co, Al and Y are particularly preferred. Further specifically, ferromagnetic powders containing from 10 to 40 atomic % of Co, from 2 to 20 atomic % of Al, and from 1 to 15 atomic % of Y, respectively based on Fe, are preferred.

The ferromagnetic metal powders may be treated with the later-described dispersants, lubricants, surfactants and antistatic agents in advance before dispersion. A small amount of water, hydroxide or oxide may be contained in the ferromagnetic metal powders. The ferromagnetic metal powders preferably have a moisture content of from 0.01 to 2%. It is preferred to optimize the moisture content of the ferromagnetic metal powders by selecting the kinds of binders. The pH of the ferromagnetic metal powders is preferably optimized by the combination with the binder to be used. The pH is generally in the range from 6 to 12, preferably from 7 to 11. Soluble inorganic ions of, e.g., Na, Ca, Fe, Ni, Sr, NH₄, SO₄, Cl, NO₂ and NO₃ are sometimes contained in the ferromagnetic powders. It is preferred that these inorganic ions are substantially not contained, but the properties of the ferromagnetic powders are not particularly affected if the total content of each ion is about 300 ppm or less. The ferromagnetic powders for use in the invention preferably have less voids and the value of the voids is preferably 20% by volume or less, and more preferably 5% by volume or less.

The crystallite size of the ferromagnetic metal powders is preferably from 8 to 20 nm, more preferably from 10 to 18 nm, and particularly preferably from 12 to 16 nm. The crystallite size is the average value obtained from the half value width of diffraction peak with an X-ray diffractometer (RINT 2000 series, manufactured by Rigaku Denki Co.) on the conditions of radiation source of CuKα1, tube voltage of 50 kV and tube current of 300 mA by a Scherrer method.

The ferromagnetic metal powders have a specific surface area (S_{BET}) measured by a BET method of preferably 30 m²/g or more and less than 50 m²/g, more preferably from 38 to 48 m²/g. When the specific surface area of the ferromagnetic metal powders is in this range, good surface properties are compatible with low noise. The pH of the ferromagnetic metal powders is preferably optimized by the combination with the binder to be used. The pH range is preferably from 4 to 12, more preferably from 7 to 10. The ferromagnetic metal powders may be subjected to surface treatment with Al, Si, P or oxides of them, if necessary, and the amount of the surface treating compound is from 0.1 to 10% based on the amount of the ferromagnetic metal powders. By the surface treatment, the adsorption amount of lubricant, e.g., fatty acid, preferably becomes 100 mg/m² or less. Soluble inorganic ions of, e.g., Na, Ca, Fe, Ni and Sr, are sometimes contained in the ferromagnetic powders, but the properties of the ferromagnetic powders are not particularly affected if the content is 200 ppm or less. The ferromagnetic metal powders for use in the invention preferably have less voids and the value of the voids is preferably 20% by volume or less, and more preferably 5% by volume or less.

The shape of the ferromagnetic metal powders is not particularly restricted so long as the above cubic volume of the particle is satisfied, and any shape such as an acicular, granular, ellipsoidal or tabular shape may be used, but it is particularly preferred to use acicular ferromagnetic metal powders. When acicular ferromagnetic metal powders are used the acicular ratio is preferably from 4 to 12, more preferably from 5 to 12. The coercive force (Hc) of the ferromagnetic metal powders is preferably from 159.2 to 238.8 kA/m (from 2,000 to 3,000 Oe), more preferably from 167.2 to 230.8 kA/m (from 2,100 to 2,900 Oe). The saturation magnetic flux density of the ferromagnetic metal powders is preferably from 150 to 300 mT (from 1,500 to 3,000 G), more preferably from 160 to 290 mT The saturation magnetization (σs) is preferably from 140 to 170 A·m²/kg (from 140 to 170 emu/g), more preferably from 145 to 160 A·m²/kg. SFD (Switching Field Distribution) of the magnetic powders themselves is preferably small, preferably 0.8 or less. When SFD is 0.8 or less, electromagnetic characteristics are excellent, high output can be obtained, magnetic flux revolution becomes sharp and peak shift becomes small, so that suitable for high density digital magnetic recording. To achieve small Hc distribution, making particle size distribution of goethite in the ferromagnetic metal powders good, using monodispersed α-Fe₂O₃, and preventing sintering among particles are effective methods.

Ferromagnetic metal powders manufactured by well-known methods can be used in the invention, and such methods include a method of reducing a water-containing iron oxide having been subjected to sintering preventing treatment, or an iron oxide with reducing gas, e.g., hydrogen, to thereby obtain Fe or Fe—Co particles; a method of reducing a composite organic acid salt (mainly an oxalate) with reducing gas, e.g., hydrogen; a method of thermally decomposing a metal carbonyl compound; a method of reduction by adding a reducing agent, e.g., sodium boron hydride, hypophosphite or hydrazine, to an aqueous solution of a ferromagnetic metal; and a method of evaporating a metal in low pressure inert gas to thereby obtain powder. The thus obtained ferromagnetic metal powder is subjected to well known gradual oxidation treatment. A method of reducing a water-containing iron oxide or an iron oxide with reducing gas, e.g., hydrogen, and forming an oxide film on the surface of the obtained ferromagnetic metal powder by regulating partial pressure of oxygen-containing gas and inert gas, the temperature and the time is little in demagnetization and preferred.

Ferromagnetic Hexagonal Ferrite Powder:

The examples of the ferromagnetic hexagonal ferrite powders include barium ferrite, strontium ferrite, lead ferrite, calcium ferrite, and Co substitution products of these ferrites. More specifically, magnetoplumbite type barium ferrite and strontium ferrite, magnetoplumbite type ferrites having covered the particle surfaces with spinel, and magnetoplumbite type barium ferrite and strontium ferrite partially containing spinel phase are exemplified. The ferromagnetic hexagonal ferrite powders may contain, in addition to the prescribed atoms, the following atoms, e.g., Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge and Nb. In general, ferromagnetic hexagonal ferrite powders containing the following elements can be used, e.g., Co—Zn, Co—Ti, Co—Ti—Zr, Co—Ti—Zn, Ni—Ti—Zn, Nb—Zn—Co, Sb—Zn—Co and Nb—Zn. According to starting materials and manufacturing methods, specific impurities may be contained.

The particle sizes of the ferromagnetic hexagonal ferrite powders are sizes satisfying the above specified cubic volume. The average tabular ratio [the average of (tabular diameter/tabular thickness)] of the ferromagnetic hexagonal ferrite powders is from 1 to 15, preferably from 1 to 7. When the average tabular ratio is in the range of from 1 to 15, sufficient orientation can be attained while maintaining high packing density in a magnetic layer and, at the same time, the increase of noise due to stacking among particles can be prevented. The specific surface area measured by a BET method of particles in the above particle size range is from 10 to 200 m²/g. The specific surface area nearly coincides with the calculated value from the tabular diameter and the tabular thickness of a particle.

The distribution of tabular diameter tabular thickness of the ferromagnetic hexagonal ferrite powders is generally preferably as narrow as possible. Tabular diameter-tabular thickness of particles can be compared in numerical values by measuring 500 particles selected randomly from TEM photographs. The distributions of tabular diameter-tabular thickness of particles are in many cases not regular distributions, but when expressed in the standard deviation to the average particle size by calculation, σ/average size is from 0.1 to 2.0. For obtaining narrow particle size distribution, it is effective to make a particle-forming reaction system homogeneous as far as possible, and to subject particles-formed to distribution-improving treatment as well. For instance, a method of selectively dissolving superfine particles in an acid solution is also known.

The coercive force (Hc) of the hexagonal ferrite particles can be made from 159.2 to 238.8 kA/m (from 2,000 to 3,000 Oe), but Hc is preferably from 175.1 to 222.9 kA/m (from 2,200 to 2,800 Oe), and more preferably from 183.1 to 214.9 kA/m (from 2,300 to 2,700 Oe). However, when the saturation magnetization (σₛ) of the head exceeds 1.4 T, it is preferred that Hc is 159.2 kA/m or less. Coercive force (Hc) can be controlled by the particle size (tabular diameter-tabular thickness), the kinds and amounts of the elements contained in the hexagonal ferrite powder, the substitution sites of the elements, and the particle forming reaction conditions.

The saturation magnetization (σₛ) of the hexagonal ferrite particles is preferably from 40 to 80 A·m²/kg (emu/g). Saturation magnetization (σₛ) is preferably higher, but it has the inclination of becoming smaller as particles become finer. For improving saturation magnetization (σₛ), compounding spinel ferrite to magnetoplumbite ferrite, and the selection of the kinds and the addition amount of elements to be contained are well known. It is also possible to use W-type hexagonal ferrite. In dispersing magnetic powders, the particle surfaces of magnetic particles may be treated with dispersion media and substances compatible with the polymers. Inorganic and organic compounds are used as the surface-treating agents. For example, oxides or hydroxides of Si, Al and P, various kinds of silane coupling agents and various kinds of titanium coupling agents are primarily used as such surface-treating agents. The addition amount of these surface-treating agents is from 0.1 to 10 mass % based on the mass of the magnetic powder. The pH of magnetic powders is also important for dispersion, and the pH is generally from 4 to 12 or so. The optimal value of the pH is dependent upon dispersion media and polymers. Taking the chemical stability and the preservation stability of the medium into consideration, pH of from 6 to 11 or so is selected. The moisture content in magnetic powders also affects dispersion. The optimal value of the moisture content is dependent upon dispersion media and polymers, and the moisture content of from 0.01 to 2.0% is selected in general.

The manufacturing methods of ferromagnetic hexagonal ferrite powders include the following methods and any of these methods can be used in the invention with no restriction: (1) a glass crystallization method comprising the steps of mixing barium oxide, iron oxide, metallic oxide which substitutes iron and boron oxide as a glass-forming material so as to make a desired ferrite composition, melting and then quenching the ferrite composition to obtain an amorphous product, treating by reheating, washing and pulverizing the amorphous product, to thereby obtain barium ferrite crystal powder; (2) a hydrothermal reaction method comprising the steps of neutralizing a solution of barium ferrite composition metallic salt with an alkali, removing the byproducts produced, heating the liquid phase at 100° C. or more, washing, drying and then pulverizing, to thereby obtain barium ferrite crystal powder; and (3) a coprecipitation method comprising the steps of neutralizing a solution of barium ferrite composition metallic salt with an alkali, removing the byproducts produced and drying, treating the system at 1,100° C. or less, and then pulverizing to obtain barium ferrite crystal powder. Ferromagnetic hexagonal ferrite powders may be subjected to surface treatment with Al, Si, P or oxides of them, if necessary, and the amount of the surface-treating compound is from 0.1 to 10% based on the amount of the ferromagnetic powders. By the surface treatment, the adsorption amount of lubricant, e.g., fatty acid, preferably becomes 100 mg/m² or less. Ferromagnetic powders sometimes contain soluble inorganic ions of, e.g., Na, Ca, Fe, Ni and Sr, but it is preferred that these inorganic ions are not substantially contained, but the properties of the ferromagnetic powders are not particularly influenced if the amount is 200 ppm or less.

Binder:

Conventionally well-known thermoplastic resins, thermosetting resins, reactive resins and the mixtures of these resins are used as the binder in a magnetic layer in the invention. The examples of thermoplastic resins include polymers and copolymers containing, as the constituting unit, vinyl chloride, vinyl acetate, vinyl alcohol, maleic acid, acrylic acid, acrylic ester, vinylidene chloride, acrylonitrile, methacrylic acid, methacrylic ester, styrene, butadiene, ethylene, vinyl butyral, vinyl acetal or vinyl ether; polyurethane resins and various rubber resins.

The examples of thermosetting resins and reactive resins include phenol resins, epoxy resins, curable type polyurethane resins, urea resins, melamine resins, alkyd resins, acrylic reactive resins, formaldehyde resins, silicone resins, epoxy-polyamide resins, mixtures of polyester resins and isocyanate prepolymers, mixtures of polyesterpolyol and polyisocyanate, and mixtures of polyurethane and polyisocyanate. Thermoplastic resins, thermosetting resins and reactive resins are described in detail in Plastic Handbook, Asakura Shoten.

When an electron beam-curable resin is used in a magnetic layer, not only film strength and durability are improved but also surface smoothness and electromagnetic characteristics are further improved. The examples of these resins and manufacturing methods are disclosed in JP-A-62-256219 in detail.

The above resins can be used alone or in combination. It is particularly preferred to use polyurethane resins. It is more preferred to use hydrogenated bisphenol A; polyurethane resins obtained by reacting a compound having a cyclic structure such as polypropylene oxide adduct of hydrogenated bisphenol A, polyol having an alkylene oxide chain and a molecular weight of from 500 to 5,000, polyol having a cyclic structure and a molecular weight of from 200 to 500 as the chain extender, and organic diisocyanate, and introducing a polar group thereto; polyurethane resins obtained by reacting aliphatic dibasic acid such as succinic acid, adipic acid or sebacic acid, polyester polyol comprising aliphatic diol not having a cyclic structure and having a branched alkyl side chain such as 2,2-dimethyl-1,3-propanediol, 2-ethyl-2-butyl-1,3-propanediol, or 2,2-diethyl-1,3-propanediol, aliphatic diol having a branched alkyl side chain and having 3 or more carbon atoms such as 2-ethyl-2-butyl-1,3-propanediol or 2,2-diethyl-1,3-propanediol as the chain extender, and an organic diisocyanate compound, and introducing a polar group thereto; or polyurethane resins obtained by reacting a compound having a cyclic structure such as dimer diol, a polyol compound having a long alkyl chain, and organic diisocyanate, and introducing a polar group thereto.

The average molecular weight of the polar group-containing polyurethane resins for use in the invention is preferably from 5,000 to 100,000, more preferably from 10,000 to 50,000. When the average molecular weight is 5,000 or more; a magnetic layer to be obtained is not accompanied by the reduction of physical strength, such as brittleness of the layer, and the durability of the magnetic recording medium is not influenced. While when the average molecular weight is 100,000 or less, the solubility in a solvent does not decrease, so that good dispersibility can be obtained, in addition, the coating viscosity in the prescribed concentration does not increase, so that good working properties can be obtained and handling is easy.

As the polar groups contained in the above polyurethane resins, —COOM, —SO₃M, —OSO₃M, —P═O(OM)₂, —O—P═O(OM)₂ (wherein M represents a hydrogen atom or an alkali metal salt group), —OH, —NR₂, —N⁺R₃ (wherein R represents a hydrocarbon group), an epoxy group, —SH and —CN are exemplified. Polyurethane resins to which one or more of these polar groups are introduced by copolymerization or addition reaction can be used. When these polar group-containing polyurethane resins have an OH group, to have a branched OH group is preferred from the aspects of curability and durability, to have from 2 to 40 branched OH groups per a molecule is preferred, and to have from 3 to 20 branched OH groups is more preferred. The amount of these polar groups is from 10⁻³ to 10⁻⁹ mol/g, preferably from 10⁻² to 10⁻¹ mol/g.

The specific examples of binders include VAGH, VYHH, VMCH, VAGF, VAGD, VROH, VYES, VYNC, VMCC, XYHL, XYSG, PKHH, PKHJ, PKHC and PKFE (manufactured by Union Carbide Co., Ltd.), MPR-TA, MPR-TA5, MPR-TAL, MPR-TSN, MPR-TMF, MPR-TS, MPR-TM and MPR-TAO (manufactured by Nisshin Chemical Industry Co., Ltd.), 1000W, DX80, DX81, DX82, DX83 and 100FD (manufactured by Electro Chemical Industry Co., Ltd.), MR-104, MR-105, MR-110, MR-100, MR-555 and 400X-110A (manufactured by Nippon Zeon Co., Ltd.), Nippollan N2301, N₂₃₀₂ and N₂₃₀₄ (manufactured by Nippon Polyurethane Co., Ltd.), Pandex T-5105, T-R3080, T-5201, Burnock D-400, D-210-80, Crisvon 6109 and 7209 (manufactured by Dainippon Ink and Chemicals Inc.), Vylon UR8200, UR8300, UR8700, RV530 and RV280 (manufactured by Toyobo Co., Ltd.), Daipheramine 4020, 5020, 5100, 5300, 9020, 9022 and 7020 (manufactured by Dainichiseika Color & Chemicals Mfg. Co., Ltd.), MX5004 (manufactured by Mitsubishi Kasei Corp.), Sanprene SP-150 (manufactured by Sanyo Chemical Industries Ltd.), Saran F310 and F210 (manufactured by Asahi Kasei Corporation).

The addition amount of the binders for use in a magnetic layer in the invention is from 5 to 50 mass %, preferably from 10 to 30 mass %, based on the mass of the ferromagnetic metal powder. When polyurethane resins are used, the amount is from 2 to 20 mass %, when polyisocyanate is used, the amount is from 2 to 20 mass %, and it is preferred to use them in combination, however, for instance, when corrosion of the head is caused by a slight amount of chlorine due to dechlorination, it is possible to use polyurethane alone or a combination of polyurethane and isocyanate alone. When a vinyl chloride resin is used as other resin, the addition amount is preferably from 5 to 30 mass %. When polyurethane is used in the invention, the polyurethane has a glass transition temperature of preferably from −50 to 150° C., more preferably from 0 to 100° C., a breaking extension of preferably from 100 to 2,000, a breaking stress of preferably from 0.49 to 98 MPa (from 0.05 to 10 kg/mm²), and a yielding point of preferably from 0.49 to 98 MPa (from 0.05 to 10 kg/mm²).

When the magnetic recording medium according to the present invention is, for example, a floppy disc, the medium may comprise two or more layers on both sides of a support. Accordingly, the amount of a binder, the amounts of a vinyl chloride resin, a polyurethane resin, polyisocyanate or other resins contained in the binder, the molecular weight of each resin constituting the magnetic layer, the amount of polar groups, or the above described physical properties of resins can of course be varied in the nonmagnetic layer and the magnetic layer, according to necessity. These factors should be rather optimized in respective layers, and well-known prior techniques with respect to the multilayer magnetic layer can be used in the present invention. For example, when the amount of a binder is varied in each layer, it is effective to increase the amount of the binder contained in the magnetic layer to reduce scratches on the surface of the magnetic layer. For improving the head touch against a head, it is effective to increase the amount of the binder in the nonmagnetic layer to impart flexibility.

The examples of polyisocyanates usable in the invention include isocyanates, e.g., tolylene diisocyanate, 4,4′-diphenylmethane diisocyanate, hexamethylene diisocyanate, xylylene diisocyanate, naphthylene-1,5-diisocyanate, o-toluidine diisocyanate, isophorone diisocyanate and triphenylmethane triisocyanate; products of these isocyanates with polyalcohols; and polyisocyanates formed by condensation reaction of isocyanates. These isocyanates are commercially available under the trade names of Coronate L, Coronate HL, Coronate 2030, Coronate 2031, Millionate MR and Millionate MTL (manufactured by Nippon Polyurethane Co., Ltd.), Takenate D-102, Takenate D-110N, Takenate D-200 and Takenate D-202 (manufactured by Takeda Chemical Industries, Ltd.), and Desmodur L, Desmodur IL, Desmodur N and Desmodur HL (manufactured by Sumitomo Bayer Co., Ltd.). These compounds may be used alone, or in combination of two or more in each layer taking advantage of the difference in curing reactivity.

If necessary, additives can be added to a magnetic layer in the invention. As the additives, an abrasive, a lubricant, a dispersant, an auxiliary dispersant, an antifungal agent, an antistatic agent, an antioxidant, a solvent and carbon black can be exemplified. The examples of additives usable in the invention include molybdenum disulfide, tungsten disulfide, graphite, boron nitride, graphite fluoride, silicone oil, silicone having a polar group, fatty acid-modified silicone, fluorine-containing silicone, fluorine-containing alcohol, fluorine-containing ester, polyolefin, polyglycol, polyphenyl ether, aromatic ring-containing organic phosphonic acids, e.g., phenylphosphonic acid, benzylphosphonic acid, phenethylphosphonic acid, α-methylbenzylphosphonic acid, 1-methyl-1-phenethylphosphonic acid, diphenylmethylphosphonic acid, biphenylphosphonic acid, benzylphenylphosphonic acid, α-cumylphosphonic acid, toluylphosphonic acid, xylylphosphonic acid, ethylphenylphosphonic acids cumenylphosphonic acid, propylphenylphosphonic acid, butylphenylphosphonic acid, heptylphenylphosphonic acid, octylphenylphosphonic acid, nonylphenylphosphonic acid, and the alkali metal salts of these aromatic ring-containing organic phosphonic acids, alkylphosphonic acids, e.g., octylphosphonic acid, 2-ethylhexylphosphonic acid, isooctylphosphonic acid, isononylphosphonic acid, isodecylphosphonic acid, isoundecylphosphonic acid, isododecylphosphonic acid, isohexadecylphosphonic acid, isooctadecylphosphonic acid, isoeicosylphosphonic acid, and the alkali metal salts of these alkylphosphonic acids, aromatic phosphoric esters, e.g., phenyl phosphate, benzyl phosphate, phenethyl phosphate, α-methylbenzyl phosphate, 1-methyl-1-phenethyl phosphate, diphenylmethyl phosphate, biphenyl phosphate, benzylphenyl phosphate, α-cumyl phosphate, toluyl phosphate, xylyl phosphate, ethylphenyl phosphate, cumenyl phosphate, propylphenyl phosphate, butylphenyl phosphate, heptylphenyl phosphate, octylphenyl phosphate, nonylphenyl phosphate, and the alkali metal salts of these aromatic phosphoric esters, alkylphosphoric esters, e.g., octyl phosphate, 2-ethylhexyl phosphate, isooctyl phosphate, isononyl phosphate, isodecyl phosphate, isoundecyl phosphate, isododecyl phosphate, isohexadecyl phosphate, isooctadecyl phosphate, isoeicosyl phosphate, and the alkali metal salts of these alkylphosphoric esters, alkylsulfonic esters and the alkali metal salts of the alkylsulfonic esters, fluorine-containing alkylsulfuric esters and the alkali metal salts of the fluorine-containing alkylsulfuric esters, monobasic fatty acids having from 10 to 24 carbon atoms (which may contain an unsaturated bond or may be branched), e.g., lauric acid, myristic acid, palmitic acid, stearic acid, behenic acid, butyl stearate, oleic acid, linoleic acid, linolenic acid, elaidic acid, erucic acid, and the alkali metal salts of these monobasic fatty acids, fatty acid monoesters, fatty acid diesters or polyhydric fatty acid esters composed of monobasic fatty acid having from 10 to 24 carbon atoms (which may contain an unsaturated bond or may be branched), e.g., butyl stearate, octyl stearate, amyl stearate, isooctyl stearate, octyl myristate, butyl laurate, butoxyethyl stearate, anhydrosorbitan monostearate, anhydrosorbitan tristearate, and any one of mono-, di-, tri-, tetra-, penta- or hexa-alcohols having from 2 to 22 carbon atoms (which may contain an unsaturated bond or may be branched), alkoxy alcohols having from 12 to 22 carbon atoms (which may contain an unsaturated bond or may be branched) or monoalkyl ether of alkylene oxide polymerized products, fatty acid amides having from 2 to 22 carbon atoms, and aliphatic amines having from 8 to 22 carbon atoms. Besides the above hydrocarbon groups, those having a nitro group, an alkyl, aryl, or aralkyl group substituted with a group other than a hydrocarbon group, such as halogen-containing hydrocarbon, e.g., F, Cl, Br, CF₃, CCl₃, CBr₃, may be used.

In addition, nonionic surfactants, e.g., alkylene oxide, glycerol, glycidol, alkylphenol ethylene oxide adducts, etc., cationic surfactants, e.g., cyclic amine, ester amide, quaternary ammonium salts, hydantoin derivatives, heterocyclic rings, phosphoniums and sulfoniums, anionic surfactants containing an acid group, e.g., carboxylic acid, sulfonic acid or a sulfuric ester group, and amphoteric surfactants, e.g., amino acids, aminosulfonic acids, sulfuric or phosphoric esters of amino alcohol, and alkylbetaine can also be used. The details of these surfactants are described in Kaimen Kasseizai Binran (Handbook of Surfactants), Sangyo Tosho Publishing Co., Ltd.

These lubricants and antistatic agents need not be 100% pure and may contain impurities such as isomers, unreacted products, side reaction products, decomposed products and oxides, in addition to the main components. However, the content of such impurities is preferably 30 mass % or less, and more preferably 10 mass % or less.

As the specific examples of these additives, e.g., NAA-102, castor oil hardened fatty acid, NAA-42, Cation SA, Naimeen L-201, Nonion E-208, Anon BF and Anon LG (manufactured by Nippon Oils and Fats Co., Ltd.), FAL-205 and FAL-123 (manufactured by Takemoto Oil & Fat), Enujerubu OL (manufactured by New Japan Chemical Co., Ltd.), TA-3 (manufactured by Shin-Etsu Chemical Co., Ltd.), Armide P (manufactured by LION AKZO CO., LTD.), Duomeen TDO (manufactured by Lion Corporation), BA-41C (manufactured by The Nisshin OilliO Group, Ltd.), Profan 2012E, Newpole PE61 and lonet MS-400 (manufactured by Sanyo Chemical Industries Ltd.) are exemplified.

Carbon blacks can be added to a magnetic layer in the invention, if necessary. Carbon blacks usable in a magnetic layer are furnace blacks for rubbers, thermal blacks for rubbers, carbon blacks for coloring, and acetylene blacks. The carbon blacks for use in the invention preferably have a specific surface area of from 5 to 500 m²/g, a DBP oil absorption amount of from 10 to 400 ml/100 g, an average particle size of from 5 to 300 mμ, a pH value of from 2 to 10, a moisture content of from 0.1 to 10%, and a tap density of from 0.1 to 1 g/ml.

The specific a les of the carbon blacks for use in the invention include BLACKPEARLS 2000, 1300, 1000, 900, 905, 800, 700, and VULCAN XC-72 (manufactured by Cabot Co., Ltd.), #80, #60, #55, #50 and #35 (manufactured by ASAHI CARBON CO., LTD.), #2400B, #2300, #900, #1000, #30, #40 and #10B (manufactured by Mitsubishi Kasei Corp.), CONDUCTEX SC, RAVEN 150, 50, 40, 15, and RAVEN-MT-P (manufactured by Columbia Carbon Co., Ltd.), and Ketjen Black EC (manufactured by Nippon EC Co., Ltd.). The carbon blacks may be surface-treated with a dispersant in advance, may be grafted with resins, or a part of the surface may be graphitized before use. The carbon blacks may be previously dispersed in a binder before being added to a magnetic coating solution. These carbon blacks can be used alone or in combination. It is preferred to use carbon blacks in an amount of from 0.1 to 30 mass % based on the mass of the magnetic powder. Carbon blacks can serve various functions such as preventing the static charge and reducing the friction coefficient of a magnetic layer, imparting a light-shielding property to a magnetic layer, and improving the film strength of a magnetic layer. Such functions vary by the kind of the carbon black to be used. Accordingly, it is of course possible in the invention to select and determine the kinds, amounts and combinations of the carbon blacks to be added to a magnetic layer and a nonmagnetic layer, on the basis of the above described various properties such as the particle size, the oil absorption amount, the electrical conductance and the pH value, or these should be rather optimized in each layer. With respect to the carbon blacks usable in a magnetic layer of the invention, Carbon Black Binran (Handbook of Carbon Blacks) (edited by Carbon Black Association) can be referred to.

Well-known organic solvents can be used in the invention. Organic solvents are used in an optional rate in the invention. The examples of the organic solvents for use in the invention include ketones, e.g., acetone, methyl ethyl ketone, methyl isobutyl ketone, diisobutyl ketone, cyclohexanone, isophorone and tetrahydrofuran; alcohols, e.g., methanol, ethanol, propanol, butanol, isobutyl alcohol, isopropyl alcohol and methylcyclohexanol; esters, e.g., methyl acetate, butyl acetate, isobutyl acetate, isopropyl acetate, ethyl lactate and glycol acetate; glycol ethers, e.g., glycol dimethyl ether, glycol monoethyl ether and dioxane; aromatic hydrocarbons, e.g., benzene, toluene, xylene, cresol and chlorobenzene; chlorinated hydrocarbons, e.g., methylene chloride, ethylene chloride, carbon tetrachloride, chloroform, ethylene chlorohydrin and dichlorobenzene; and N,N-dimethylformamide and hexane.

These organic solvents need not be 100% pure and they may contain impurities such as isomers, unreacted products, side reaction products, decomposed products, oxides, and water in addition to their main components. However, the content of such impurities is preferably 30 mass % or less, and more preferably 10 mass % or less. It is preferred that the same kind of organic solvents are used in a magnetic layer and a nonmagnetic layer, but the addition amounts may differ. It is preferred to use organic solvents having high surface tension (such as cyclohexanone, dioxane and the like) in a nonmagnetic layer to thereby increase coating stability. Specifically, it is important for the arithmetic mean value of the surface tension of the composition of the solvents in an upper layer not to be lower than the arithmetic mean value of the surface tension of the composition of the solvents in a nonmagnetic layer. For improving dispersibility, the porality is preferably strong in a certain degree, and it is preferred that solvents having a dielectric constant of 15 or more account for 50% or more of the composition of the solvents. The dissolution parameter is preferably from 8 to 11.

The kinds and the amounts of these dispersants, lubricants and surfactants for use in the invention can be used differently in a magnetic layer and a nonmagnetic layer described later, according to necessity. For example, although these are not limited to the examples described here, dispersants have a property of adsorbing or bonding by the polar groups, and dispersants are adsorbed or bonded by the polar groups mainly to the surfaces of ferromagnetic metal powder particles in a magnetic layer and mainly to the surfaces of nonmagnetic powder particles in a nonmagnetic layer, and it is supposed that an organic phosphorus compound once adsorbed is hardly desorbed from the surface of metal or metallic compound. Accordingly, the surfaces of ferromagnetic metal powder particles or nonmagnetic powder particles are in the state of being covered with alkyl groups or aromatic groups, so that the affinity of the ferromagnetic metal powder or nonmagnetic powder to the binder resin is improved, and further the dispersion stability of the ferromagnetic metal powder or nonmagnetic powder is also improved. In addition, since lubricants are present in a free state, it is effective to use fatty acids each having a different melting point in a nonmagnetic layer and a magnetic layer so as to prevent bleeding out of the fatty acids to the surface, or esters each having a different boiling point and a different polarity so as to prevent bleeding out of the esters to the surface. Also, the amount of surfactants is controlled so as to improve the coating stability, or the amount of lubricant in a nonmagnetic layer is made larger so as to improve the lubricating effect. All or a part of the additives to be used in the invention may be added to a magnetic coating solution or a nonmagnetic coating solution in any step of preparation. For example, additives may be blended with ferromagnetic powder before a kneading step, may be added in a step of kneading ferromagnetic powder, a binder and a solvent, may be added in a dispersing step, may be added after a dispersing step, or may be added just before coating.

[Nonmagnetic Layer]

A nonmagnetic layer is described in detail below. The magnetic recording medium in the invention may have a nonmagnetic layer containing a binder and nonmagnetic powder on a support. The nonmagnetic powder usable in a nonmagnetic layer may be an inorganic substance or an organic substance Carbon black can also be used in a nonmagnetic layer. As the inorganic substances, e.g., metal, metal oxide, metal carbonate, metal sulfate, metal nitride, metal carbide and metal sulfide are exemplified.

Specifically, titanium oxide, e.g., titanium dioxide, cerium oxide, tin oxide, tungsten oxide, ZnO, ZrO₂, SiO₂, Cr₂O₃, α-alumina having an α-conversion rate of from 90% to 100%, α-alumina, γ-alumina, α-iron oxide, goethite, corundum, silicon nitride, titanium carbide, magnesium oxide, boron nitride, molybdenum disulfide, copper oxide, MgCO₃; CaCO₃, BaCO₃, SrCO₃, BaSO₄, silicon carbide, and titanium carbide can be used alone or in combination of two or more. α-Iron oxide and titanium oxide are preferred.

The shape of nonmagnetic powders may be any of an acicular, spherical, polyhedral or tabular shape. The crystallite size of nonmagnetic powders is preferably from 4 nm to 1 μm, and more preferably from 40 to 100 nm. When the crystallite size of nonmagnetic powders is in the range of from 4 nm to 1 μm, dispersion can be performed easily, and preferred surface roughness can be obtained. The average particle size of nonmagnetic powders is preferably from 5 nm to 2 μm, but if necessary, a plurality of nonmagnetic powders each having a different particle size may be combined, or single nonmagnetic inorganic powder may have broad particle size distribution so as to attain the same effect as such a combination. Nonmagnetic powders particularly preferably have an average particle size of from 10 to 200 nm. When the average particle size is in the range of from 5 nm to 2 μm, preferred dispersibility and preferred surface roughness can be obtained.

Nonmagnetic powders have a specific surface area of from 1 to 100 m²/g, preferably from 5 to 70 m²/g, and more preferably from 10 to 65 m²/g. When the specific surface area is in the range of from 1 to 100 m²/g, preferred surface roughness can be secured and dispersion can be effected with a desired amount of binder. Nonmagnetic powders have an oil absorption amount using dibutyl phthalate (DBP) of generally from 5 to 100 ml/100 g, preferably from 10 to 80 ml/100 g, and more preferably from 20 to 60 ml/100 g; a specific gravity of generally from 1 to 12, and preferably from 3 to 6; a tap density of generally from 0.05 to 2 g/ml, preferably from 0.2 to 1.5 g/ml, when the tap density is in the range of 0.05 to 2 g/ml, particles hardly scatter, handling is easy, and the powders tend not to adhere to the apparatus; pH of preferably from 2 to 11, particularly preferably between 6 and 9, when the pH is in the range of from 2 to 11, the friction coefficient does not increase under high temperature and high humidity or due to liberation of fatty acid; a moisture content of generally from 0.1 to 5 mass %, preferably from 0.2 to 3 mass %, and more preferably from 0.3 to 1.5 mass %, when the moisture content is in the range of from 0.1 to 5 mass %, good dispersion is ensured and the viscosity of the coating solution after dispersion stabilizes. The ignition loss of nonmagnetic powders is preferably 20 mass % or less, and nonmagnetic powders showing small ignition loss are preferred.

When nonmagnetic powder is inorganic powder, Mohs' hardness is preferably from 4 to 10. When Mohs' hardness is in the range of from 4 to 10, durability can be secured. Nonmagnetic powder has a stearic acid adsorption amount of preferably from 1 to 20 μmol/m², more preferably from 2 to 15 μmol/m², heat of wetting to water at 25° C. of preferably from 200 to 600 erg/cm² (from 200 to 600 mJ/m²) Solvents in this range of heat of wetting can be used. The number of the molecules of water at the surface of nonmagnetic powder at 100 to 400° C. is preferably from 1 to 10/100 Å. The pH of isoelectric point in water is preferably from 3 to 9. The surfaces of nonmagnetic powders are preferably covered with Al₂O₃, SiO₂, TiO₂, ZrO₂, SnO₂, Sb₂O₃ or ZnO. Al₂O₃, SiO₂, TiO₂ and ZrO₂ are particularly preferred in dispersibility, and Al₂O₃, SiO₂ and ZrO₂ are still more preferred. These surface-covering compounds can be used in combination or can be used alone. According to purposes, nonmagnetic powder particles may have a layer subjected to surface treatment by coprecipitation. Alternatively, surfaces of particles may be covered with alumina previously, and then the alumina-covered surface may be covered with silica, or vice versa, according to purposes. A surface-covered layer may be a porous layer, if necessary, but a homogeneous and dense surface is generally preferred.

The specific examples of the nonmagnetic powders for use in a nonmagnetic layer according to the invention include Nanotite (manufactured by Showa Denko k.k.), HIT-100 and ZA-G1 (manufactured by Sumitomo Chemical Co., Ltd.), DPN-250, DPN-250BX, DPN-245, DPN-270BX, DPB-S50BX and DPN-550RX (manufactured by Toda Kogyo Corp.), titanium oxide TTO-51B, TTO-55A, TTO-55B, TTO-55C, TTO-55S, TTO-55D, SN-100, MJ-7, α-iron oxide E270, E271 and E300 (manufactured by Ishihara Sangyo Kaisha Ltd.), STT-4D, STT-30D, STT-30 and STT-6SC (manufactured by Titan Kogyo Kabushiki Kaisha), MT-100S, MT-100T, MT-150W, MT-500B, T-600B, T-100F and T-500HD (manufactured by TAYCA CORPORATION), FINEX-25, BF-1, BF-10, BF-20 and ST-M (manufactured by Sakai Chemical Industry Co., Ltd.), DEFIC-Y and DEFIC-R (manufactured by Dowa Mining Co., Ltd.), AS2BM and TiO₂ P25 (manufactured by Nippon Aerosil Co., Ltd.), 100A and 500A (manufactured by Ube Industries, Ltd.), Y-LOP and calcined products of it (manufactured by Titan Kogyo Kabushiki Kaisha). Particularly preferred nonmagnetic powders are titanium dioxide and α-iron oxide.

Surface electric resistance and light transmittance can be reduced by the addition of carbon blacks to a nonmagnetic layer with nonmagnetic powder and a desired micro Vickers hardness can be obtained at the same time. The micro Vickers hardness of a nonmagnetic layer is generally from 25 to 60 kg/mm² (from 245 to 588 MPa), preferably from 30 to 50 kg/mm² (from 294 to 940 MPa) for adjusting the head touch. Micro Vickers hardness can be measured using a triangular pyramid diamond needle having sharpness of 80° and radius of the tip of 0.1 μm attached at the tip of an indenter using a membrane hardness meter HMA-400 (manufactured by NEC Corporation). Light transmittance is standardized that the absorption of infrared ray of wavelength of about 900 nm is generally 3% or less, e.g., the light transmittance of a magnetic tape for VHS is 0.8% or less. For this purpose, furnace blacks for rubbers, thermal blacks for rubbers, carbon blacks for coloring, and acetylene blacks can be used.

The carbon blacks for use in a nonmagnetic layer in the invention have a specific surface area of generally from 100 to 500 m²/g, preferably from 150 to 400 m²/g, a DBP oil absorption of generally from 20 to 400 ml/100 g, preferably from 30 to 200 ml/100 g, a particle size of generally from 5 to 80 nm, preferably from 10 to 50 nm, and more preferably from 10 to 40 nm, pH of generally from 2 to 10, a moisture content of from 0.1 to 10%, and a tap density of preferably from 0.1 to 1 g/ml.

The specific examples of the carbon blacks for use in a nonmagnetic layer in the invention include BLACKPEARLS 2000, 1300, 1000, 900, 800, 880, 700, and VULCAN XC-72 (manufactured by Cabot Co., Ltd.), #3050B, #3150B, #3250B, #3750B, #3950B, #950, #650B, #970B, #850B and MA-600 (manufactured by Mitsubishi Kasei Corp.), CONDUCTEX SC, RAVEN 8800, 8000, 7000, 5750, 5250, 3500, 2100, 2000, 1800, 1500, 1255 and 1250 (manufactured by Columbia Carbon Co., Ltd.), and Ketjen Black EC (manufactured by Akzo Co., Ltd.).

The carbon blacks for use in the present invention may previously be surface-treated with a dispersant, may be grafted with a resin, or a part of the surface thereof may be graphitized before use. Carbon blacks may be previously dispersed in a binder before addition to a coating solution. These carbon blacks can be generally used within the range not exceeding 50 mass % based on the above inorganic powders and not exceeding 40 mass % based on the total mass of the nonmagnetic layer. These carbon blacks can be used alone or in combination. Regarding the carbon blacks for use in a nonmagnetic layer in the present invention, for example, compiled by Carbon Black Association, Carbon Black Binran (Handbook of Carbon Blacks) can be referred to.

Organic powders can be used in a nonmagnetic layer according to purpose. The examples of such organic powders include acryl styrene resin powder, benzoguanamine resin powder, melamine resin powder and a phthalocyanine pigment, in addition, polyolefin resin powders, polyester resin powders, polyamide resin powders, polyimide resin powders and polyethylene fluoride resin powders can also be used. The producing methods of these organic powders are disclosed in JP-A-62-18564 and JP-A-60-255827.

The binder resins, lubricants, dispersants, additives, solvents, dispersing methods, etc., used for a magnetic layer can be used in a nonmagnetic layer. In particular, with respect to the amounts and the kinds of binder resins, additives, and the amounts and the kinds of dispersants, well-known prior techniques regarding the magnetic layer can be applied to a nonmagnetic layer in the invention.

Further, the magnetic recording medium in the invention may be provided with an undercoat layer. Adhesion of a support and a magnetic layer or a nonmagnetic layer can be improved by providing an undercoat layer. Polyester resins soluble in a solvent are used as the undercoat layer.

Layer Constitution:

The thickness of a support of the magnetic recording medium in the invention is preferably from 3 to 80 μm. When an undercoat layer is provided between a support and a nonmagnetic layer or a magnetic layer, the thickness of the undercoat layer is from 0.01 to 0.8 μm, preferably from 0.02 to 0.6 μm.

The thickness of a magnetic layer of the magnetic recording medium of the invention is optimized according to the saturation magnetization amount of the head used, the head gap length, and the recording signal zone, and is generally from 10 to 150 nm, preferably from 20 to 80 nm, and more preferably from 30 to 80 nm. The fluctuation of a magnetic layer thickness is preferably not more than ±50%, and more preferably not more than ±40%. A magnetic layer comprises at least one layer, or may be separated to two or more layers each having different magnetic characteristics, and well-known constitutions of the multilayer magnetic layer can be used in the invention.

The thickness of a nonmagnetic layer in the present invention is generally from 0.5 to 2.0 μm, preferably from 0.8 to 1.5 μm, and more preferably from 0.8 to 1.2 μm. A nonmagnetic layer of the magnetic recording medium of the invention exhibits the effect of the invention so long as it is substantially a nonmagnetic layer even if, or intentionally, it contains a small amount of magnetic powder as impurity, which is as a matter of course regarded as essentially the same constitution as the magnetic recording medium in the invention. The term “substantially a nonmagnetic layer” means that the residual magnetic flux density of the nonmagnetic layer is 10 mT or less or the coercive force of the nonmagnetic layer is 7.96 kA/m (1000e) or less, preferably the residual magnetic flux density and the coercive force are zero.

Manufacturing Method:

The manufacturing process of a magnetic layer coating solution of the magnetic recording medium in the invention comprises at least a kneading step, a dispersing step and a blending step to be carried out optionally before and/or after the kneading and dispersing steps. Each of these steps may be composed of two or more separate-stages. All of the charge-stock such as ferromagnetic metal powder, nonmagnetic powder, a binder, a carbon black, an abrasive, an antistatic agent, a lubricant and a solvent for use in the invention may be added at any step at any time. Each charge stock may be added at two or more steps dividedly. For example, polyurethane can be added dividedly at a kneading step, a dispersing step, or a blending step for adjusting viscosity after dispersion. For achieving the object of the invention, conventionally well known techniques can be used partly with the above steps. Powerful kneading machines such as an open kneader, a continuous kneader, a pressure kneader or an extruder are preferably used in a kneading step. When a kneader is used, all or a part of the binder (preferably 30% or more of the total binder) is kneaded in the range of from 15 parts to 500 parts per 100 parts of the magnetic powder together with the magnetic powder or nonmagnetic powder. These kneading treatments are disclosed in detail in JP-A-1-106338 and JP-A-1-79274. For dispersing a magnetic layer coating solution and a nonmagnetic layer coating solution, glass beads can be used, but dispersing media having a high specific gravity, e.g., zirconia beads, titania beads and steel beads are preferred for this purpose. Optimal particle size and packing density of these dispersing media have to be selected. Well-known dispersers can be used in the invention.

In the manufacturing method of the magnetic recording medium in the invention, a magnetic layer is formed by coating a magnetic coating solution in a prescribed thickness on the surface of a support under running. A plurality of magnetic layer coating solutions may be multilayer-coated successively or simultaneously, or a nonmagnetic layer coating solution and a magnetic layer coating solution may be multilayer-coated successively or simultaneously. Air doctor coating, blade coating, rod coating, extrusion coating, air knife coating, squeeze coating, impregnation coating, reverse roll coating, transfer roll coating, gravure coating, kiss coating, cast coating, spray coating and spin coating can be used for coating the above magnetic layer coating solution or nonmagnetic layer coating solution. These coating methods are described, e.g., in Saishin Coating Gijutsu (The Latest Coating Techniques), Sogo Gijutsu Center Co. (May 31, 1983).

In the case of a tape-like magnetic recording medium, ferromagnetic metal powder contained in a coated layer of a magnetic layer coating solution is subjected to the treatment of magnetic field orientation in the machine direction using a cobalt magnet and a solenoid. In the case of a magnetic disc, isotropic orienting property can be sufficiently obtained in some cases without performing orientation with orientating apparatus, but it is preferred to use well-known random orientation apparatus, e.g., disposing cobalt magnets diagonally and alternately or applying an alternating current magnetic field with a solenoid. In the case of ferromagnetic metal powder, isotropic orienting property is generally in-plane two dimensional random orientation is preferred, but it is possible to make three dimensional random orientation by applying perpendicular factor. Hexagonal ferrite magnetic powders have generally an inclination for three-dimensional random orientation of in-plane and in the perpendicular direction, but it is also possible to make in-plane two dimensional random orientation. It is also possible to impart isotropic magnetic characteristics in the circumferential direction by perpendicular orientation using well-known methods, e.g., using different pole and counter position magnets. In particular, perpendicular orientation is preferred when the disc is used in high density recording. Circumferential orientation can also be performed using spin coating.

In orientation, it is preferred that the drying position of a coated film be controlled by controlling the temperature and the amount of drying air and coating rate. Coating rate is preferably from 20 to 1,000 m/min and the temperature of drying air is preferably 60° C. or more. Proper degree of preliminary drying can be performed before entering a magnet zone.

After drying, the coated layer is generally subjected to surface smoothing treatment with, e.g., a super calender roll and the like. The voids generated by the removal of the solvent in drying disappear by the surface smoothing treatment and the packing rate of the ferromagnetic metal powder in the magnetic layer increases, so that a magnetic recording medium having high electromagnetic characteristics can be obtained. Heat resisting plastic rolls, e.g., epoxy, polyimide, polyamide and polyimideamide are used in calendering treatment. Metal rolls can also be used in calendering treatment.

It is preferred for the magnetic recording medium in the invention to have extremely excellent surface smoothness as high as from 0.1 to 4 nm of central plane average surface roughness at a cut-off value of 0.25 mm, more preferably from 1 to 3 nm. Such high smoothness can be obtained by forming a magnetic layer by using the specific ferromagnetic metal powder and binder as described above, and subjecting the magnetic layer to calendering treatment. As the conditions of calendering treatment, the temperature of calender rolls is in the range of from 60 to 100° C., preferably from 70 to 100° C., and particularly preferably from 80 to 100° C., the pressure is in the range of from 100 to 500 kg/cm (from 98 to 490 kN/m), preferably from 200 to 450 kg/cm (from 196 to 441 kN/m), and particularly preferably from 300 to 400 kg/cm (from 294 to 392 kN/m).

It is necessary that the shrinkage factor of the magnetic recording medium in the invention after preservation at 70° C. 5% RH for one week is 0.040% or less. As a means of reducing thermal shrinkage factor, subjecting a support, a coated medium or a medium having been subjected to calendering treatment to heat treatment (e.g., from 100 to 150° C.) with handling under low tension in a web state is known.

A magnetic recording medium obtained is cut in a desired size with a cutter. The cutter is not particularly restricted, but those having a plurality of pairs of rotating upper blade (a male blade) and lower blade (a female blade) are preferred, so that a slitting rate, the depth of intermeshing, the peripheral ratio of upper blade (male blade) and lower blade (female blade) (peripheral speed of upper blade/peripheral speed of lower blade), and the continuous working time of slitting blades can be arbitrarily selected.

Physical Characteristics:

The saturation magnetic flux density of a magnetic layer of the magnetic recording medium for use in the invention is preferably from 100 to 300 mT. The coercive force (Hc) of a magnetic layer is preferably from 143.3 to 318.4 kA/m (from 1,800 to 4,000 oe), more preferably from 159.2 to 278.6 kA/m (from 2,000 to 3,500 Oe). The coercive force distribution is preferably narrow, and SFD and SFDr is preferably 0.6 or less, more preferably 0.2 or less.

The magnetic recording medium in the invention has a friction coefficient against a head at temperature of −10° C. to 40° C. and humidity of 0% to 95% of 0.5 or less, preferably 0.3 or less, surface intrinsic viscosity of a magnetic surface is preferably from 10⁴ to 10¹² Ω/sq, and a charge potential of preferably from −500 V to +500 V. The elastic modulus at 0.5% elongation of a magnetic layer is preferably from 0.98 to 19.6 GPa (from 100 to 2,000 kg/mm²) in every direction of in-plane, the breaking strength is preferably from 98 to 686 MPa (from 10 to 70 kg/mm²), the elastic modulus of the magnetic recording medium is preferably from 0.98 to 14.7 GPa (from 100 to 1,500 kg/mm²) in every direction of in-plane, the residual elongation is preferably 0.5% or less, and the thermal shrinkage factor at every temperature of 100° C. or less is preferably 1% or less, more preferably 0.5% or less, and most preferably 0.1% or less.

The glass transition temperature of a magnetic layer (the maximum point of the loss elastic modulus by dynamic viscoelasticity measurement at 110 Hz) is preferably from 50° C. to 180° C., and that of a nonmagnetic layer is preferably from 0° C. to 180° C. The loss elastic modulus is preferably in the range of from 1×10⁷ to 8×10⁸ Pa (1×10⁸ to 8×10⁹ dyne/cm²), and loss tangent is preferably 0.2 or less. When loss tangent is too large, adhesion failure is liable to occur. These thermal and mechanical characteristics are preferably almost equal in every direction of in-plane of the medium with difference of not more than 10%.

The residual amount of a solvent in a magnetic layer is preferably 100 mg/m² or less, more preferably 10 mg/m² or less. The void ratio of a coated layer is preferably 30% by volume or less, more preferably 20% by volume or less, with both of a nonmagnetic layer and a magnetic layer. The void ratio is preferably smaller for obtaining high output but in some cases a specific value should be preferably secured depending on purposes. For example, in a disc medium that is repeatedly used, large void ratio contributes to good running durability in many cases.

A magnetic layer preferably has a maximum height (SRₘₐₓ) of 0.5 μm or less, a ten point average roughness (SRz) of 0.3 μm or less, a central plane peak height (SRp) of 0.3 μm or less, a central plane valley depth (SRv) of 0.3 μm or less, a central plane area factor (SSr) of from 20 to 80%, and an average wavelength (Sλa) of from 5 to 300 μm. These can be easily controlled by the control of the surface property of a support by using fillers or by the surface configurations of the rolls of calender treatment. Curling is preferably within ±3 mm.

When the magnetic recording medium of the invention comprises a nonmagnetic layer and a magnetic layer, these physical properties can be varied according to purposes in a nonmagnetic layer and a magnetic layer. For example, the elastic modulus of a magnetic layer is made higher to improve running durability and at the same time the elastic modulus of a nonmagnetic layer is made lower than that of the magnetic layer to improve the bead touching of the magnetic recording medium.

### EXAMPLES

The invention will be described more specifically with referring to examples and comparative examples. In the examples “parts” means “mass parts” unless otherwise indicated.

<Manufacture of Coating Solution>

Magnetic Coating Solution:

| | | |
|---|---|---|
| Barium ferrite magnetic powder | 100 | parts |
| Composition in molar ratio based on Ba: | | |
| Fe: 9.10, Co: 0.22, Zn: 0.71 | | |
| Hc: 2,400 Oe (192 kA/m) | | |
| S_{BET}: 70 m²/g | | |
| σₛ: 52 A·m²/kg | | |
| Average tabular diameter: 22 nm | | |
| Average tabular ratio: 3.0 | | |
| Polyurethane resin | 10 | parts |
| Diamond | 3 | parts |
| MD 150 (manufactured by Tomei Diamond Co.) | | |
| Carbon black | 1 | part |
| #50 (manufactured by ASAHI CARBON CO., LTD.) | | |
| Oleic acid | 1 | part |
| Stearic acid | 1 | part |
| Methyl ethyl ketone | 125 | parts |
| Cyclohexanone | 125 | parts |

Nonmagnetic Coating Solution:

| | | |
|---|---|---|
| Nonmagnetic powder, α-Fe₂O₃, hematite | 80 | parts |
| Average long axis length: 0.08 μm | | |
| S_{BET}: 60 m²/g | | |
| pH: 9 | | |
| Surface-covering compound: Al₂O₃, | | |
| 8 mass % of the entire particles | | |
| Carbon black | 15 | parts |
| Conductex SC-U (manufactured by Columbia Carbon | | |
| Co., Ltd.) | | |
| Polyurethane resin | 12 | parts |
| UR8200 (manufactured by Toyobo Co., Ltd.) | | |
| Oleic acid | 2 | parts |
| Stearic acid | 2 | parts |
| Phenylphosphonic acid | 5 | parts |
| Methyl ethyl ketone/cyclohexanone | 250 | parts |
| (8/2 mixed solvent) | | |

<Manufacture of Magnetic Disc Medium>

Each component of the above magnetic layer coating solution and nonmagnetic layer coating solution was kneaded in a kneader and then dispersed in a sand mill. An isocyanate curing agent was added in an amount of 6 parts to the nonmagnetic layer coating solution and 3 parts to the magnetic layer coating solution. Further, 40 parts of cyclohexanone was added to each solution, and each solution was filtered through a filter having an average pore diameter of 1 μm to thereby obtain coating solutions for forming a nonmagnetic layer and a magnetic layer.

The obtained nonmagnetic layer coating solution was coated in a dry thickness of 1.2 μm on a support and once dried, the magnetic layer coating solution was coated thereon in a prescribed thickness (0.1 μm) by blade coating and dried, and then subjected to calendering treatment with a calender of seven stages at 90° C. and a linear pressure of 300 m/min (294 kN/m), and punched to a disc having a diameter of 1.8 inches The disc was subjected to thermo-treatment at 55° C. to accelerate the hardening treatment of the coated layer. The samples in Examples and Comparative Examples were manufactured in the same manner.

Polyester supports manufactured by changing the stretching condition and heat treatment condition as shown in Table 1 were used.

Each sample obtained was subjected to the following measurement.

Measurement of Curling:

The central position of each magnetic disc was fixed and stood perpendicularly, and the displacement at the position 22 mm from the central position by one round of the magnetic disc was measured with a laser displacement meter (LK-031, manufactured by Keyence Corporation), and the maximum value of the absolute value was taken as the amount of curl.

Measurement of Thermal Shrinkage Factor:

Each magnetic disc was preserved at 70° C. 5% RH for one week, and the dimensions before and after preservation were measured at 23° C. 45% RH with a measuring microscope (MM-60/L3, manufactured by Nikon Corporation), and the rate of change was taken as the thermal shrinkage factor.

Waveform of Envelope:

A magnetic disc was rotated at 3,000 rpm, and recording and reproduction were carried out with a composite type AMR head at a write track width of 1.5 μm, gap length of 0.3 μm, and read track width of 0.9 μm, so that the recording density at the position 18 mm from the central position became 180 KFCI. The waveform of envelope was observed with an oscilloscope, and the turbulence of the waveform due to head touch failure was evaluated as follows.
x: The turbulence of the waveform was great.
Δ: The turbulence of the waveform was observed.
◯Δ: The turbulence of the waveform was observed a little.
◯: The turbulence of the waveform was not observed.
   Evaluation of Crystal Part by ATR-FT-IR:

The crystal part of each polyester support used in the manufacture of the magnetic recording medium was evaluated by ATR-FT-IR method.

The measurement was performed with Nexus 670 (a trade name, manufactured by Thermo-Nicolet) and a one-time reflection accessory (Ge, the angle of incidence: 45°) at resolution of 1 cm⁻¹ and integration of 200 times of the same part. The spectra on the obverse and reverse surfaces of a support in the machine direction (MD) and the transverse direction (TD) at the time of manufacture of the support were measured.

With respect to polyethylene naphthalate (PEN), as the index of the degree of crystallization, the absorbance of peak of γω(CH₂) gauche of 1,370 cm⁻¹ was found, further the absorbance of peak of γω(CH₂) trans of 1,337 cm⁻¹ was found, and the peak intensity ratio of gauche/trans (the peak intensity ratio of gauche to that of trans) was obtained from the measured values.

With respect to polyethylene terephthalate (PET), as the index of the degree of crystallization, the absorbance of peak of γω((CH₂) gauche of 1,365 cm⁻¹ was found, further the absorbance of peak of γω(CH₂) trans of 1,337 cm⁻¹ was found, and the peak intensity ratio of gauche/trans was obtained from the measured values.

To each support, four peak intensity ratios of gauche/trans on the obverse and reverse surfaces in the machine direction (MD) and the transverse direction (TD) (a peak intensity ratio of gauche/trans on the obverse surface in the machine direction, a peak intensity ratio of gauche/trans on the obverse surface in the transverse direction, a peak intensity ratio of gauche/trans on the reverse surface in the machine direction and a peak intensity ratio of gauche/trans on the reverse surface in the transverse direction) was obtained.

The difference between the largest ratio and the smallest ratio among the peak intensity ratios of gauche/trans on the obverse and reverse surfaces in the machine direction (MD) and the transverse direction (TD) of each of the polyester supports was obtained as the absolute value.

The results obtained are shown in Table 1 below.

TABLE 1

| | | | | | | Difference between the largest | |
|---|---|---|---|---|---|---|---|
| | | | | | | and the smallest ratios among Peak | |
| | | | Thermal | | | Intensity Ratios of Gauche/Trans | |
| | | Kind of | Shrinkage | | Waveform | of obverse and reverse surfaces in | |
| Medium | | Polyester | Factor | Curling | of | machine and transverse directions | Total |
| No. | Remarks | Support | (%) | (mm) | Envelope | of the support (absolute value) | Evaluation |
| 1 | Comparative | PET | 0.048 | 0.032 | ◯ | 0.048 | X |
| | Example | | | | | | |
| 2 | Comparative | PEN | 0.021 | 0.534 | X | 0.042 | X |
| | Example | | | | | | |
| 3 | Comparative | PEN | 0.032 | 1.205 | X | 0.035 | X |
| | Example | | | | | | |
| 4 | Example | PEN | 0.016 | 0.387 | ◯Δ | 0.020 | ◯Δ |
| 5 | Example | PEN | 0.020 | 0.105 | ◯ | 0.005 | ◯ |
| 6 | Example | PEN | 0.019 | 0.212 | ◯ | 0.012 | ◯ |
| 7 | Example | PET | 0.038 | 0.081 | ◯ | 0.005 | ◯ |

As is apparent from the results in Table 1, the samples in the Examples are free from the turbulence of the waveform and free from the dimensional fluctuation, which are remarkably excellent characteristics that cannot be seen heretofore.

This application is based on Japanese Patent application JP 2004-148749, filed May 19, 2004, the entire content of which is hereby incorporated by reference, the same as if set forth at length.

1. A magnetic recording medium comprising:
a nonmagnetic support having a first surface and a second surface; and
a magnetic layer containing ferromagnetic powder and a binder, so that the magnetic layer, the first surface and the second surface are in this order,
wherein the nonmagnetic support contains polyester, a difference between largest ratio and smallest ratio among peak intensity ratios of gauche/trans on the first and second surfaces of the support in a machine direction and a transverse direction obtained by ATR-FT-IR method is 0.030 or less in an absolute value, and a shrinkage factor of the magnetic recording medium after preservation at 70° C. 5% RH for one week is 0.040% or less.

2. The magnetic recording medium according to claim 1, further comprising a substantially nonmagnetic lower layer between the nonmagnetic support and the magnetic layer.

3. The magnetic recording medium according to claim 1, wherein the substantially nonmagnetic lower layer contains a binder and nonmagnetic powder.

4. The magnetic recording medium according to claim 1, wherein the difference between largest ratio and smallest ratio among peak intensity ratios of gauche/trans on the first and second surfaces of the support in a machine direction and a transverse direction obtained by ATR-FT-IR method is 0.02 or less in an absolute value.

5. The magnetic recording medium according to claim 1, wherein the difference between largest ratio and smallest ratio among peak intensity ratios of gauche/trans on the first and second surfaces of the support in a machine direction and a transverse direction obtained by ATR-FT-IR method is 0.016 or less in an absolute value.

6. The magnetic recording medium according to claim 4, wherein the support contains polyethylene naphthalate.

7. The magnetic recording medium according to claim 5, wherein the support contains polyethylene naphthalate.

8. The magnetic recording medium according to claim 1, wherein the nonmagnetic support further contains a filler.

9. The magnetic recording medium according to claim 1, wherein the nonmagnetic support has a thickness of from 10 to 100 μm.

10. The magnetic recording medium according to claim 1, wherein the nonmagnetic support has a thickness of from 20 to 80 μm.

11. The magnetic recording medium according to claim 1, wherein the nonmagnetic support has a central line average surface roughness of 8 nm or less.

12. The magnetic recording medium according to claim 1, wherein the nonmagnetic support has a central line average surface roughness of 6 nm or less.
